(19) United States
(12) Patent Application Publication
(10) Pub. No.: US 2015/0319162 A1
(43) Pub. Date: Nov. 5, 2015

(54) ELECTRONIC ARRANGEMENT AND METHOD FOR ENTITY-SPECIFIC TOKEN SET MANAGEMENT AND RELATED MECHANISM FOR OFFERING PERSONALIZED DIGITAL CONTENT BASED ON INTERACTIONS BETWEEN ENTITIES

(71) Applicant: TEKNOLOGIAN TUTKIMUSKESKUS VTT OY, Espoo (FI)

(72) Inventors: Ville OLLIKAINEN, Espoo (FI); Raimo LAUNONEN, Espoo (FI); Atte KORTEKANGAS, Espoo (FI)

(21) Appl. No.: 14/700,198

(22) Filed: Apr. 30, 2015

Related U.S. Application Data
(60) Provisional application No. 61/986,932, filed on May 1, 2014.

(51) Int. Cl. H04L 29/06

(52) U.S. Cl. CPC H04L 63/0823; H04L 63/10

(57) ABSTRACT

Method (501) for adapting an obtained digital first token set comprising a plurality of tokens, the first token set being associated with a first entity, such as a user of an electronic device, wherein tokens are identifiable elements of substantially no semantic value, the first token set being maintained between and updated responsive to interactions between the first entity and one or more other entities, the token sets of which are also updated based on the interactions, said method comprising detecting interaction (504, 514) between the first entity and another entity, optionally a digital media element such as a web site, web page or a digital resource accessible therethrough, a second token set being associated with the second entity, determining at least one control value (506) regarding the first token set based on the interaction, wherein interaction feedback or interaction frequency is configured to affect said at least one control value, and altering the construction of the first token set (508) in accordance with the determined at least one control value, and storing the modified token set for future adaptation in connection with interactions and provision of recommendations. A related arrangement is presented.

### FIELD OF THE INVENTION

Generally the present invention relates to electronic computing devices, communications systems and various resources, such as media elements, accessible therewith. Particularly, however not exclusively, the present invention pertains to maintaining entity-specific token sets and provision of user privacy-preserving recommendations of entities based on the monitoring and analysis of interactions between the entities.

### BACKGROUND

Recommendations have become essential in creating additional value for service providers including e.g. mobile service providers. Contexts play a focal role in understanding what the users of a mobile service want or need. Thus, understanding a user's context and acting based upon it is of the utmost importance for a service to be successful. According to a more general approach, it can be said that there are numerous computational problems, the purpose of which is to predict the behavior of an entity, and for these problems e.g. genetic algorithms are applicable. Also, genetic algorithms can be used for understanding the context of a user and making recommendations thereafter.

The recommendation problem can be defined as estimation of the response of a user for new items, based on e.g. historical information stored in the system, and suggesting to this user novel and original items for which the predicted response is high (e.g. Desrosiers, C., Karypis, G.: A comprehensive survey of neighborhood-based recomnendation methods. pp. 107-144. Boston, Mass.: Springer US, 2011). Various recommending algorithms have been proposed in the literature, most commonly classified into two basic categories: content-based and collaborative recommendations. Content-based recommendation methods are based on representing the items with a set of attributes, and using these attributes to find most relevant content for a user. Collaborative recommendation methods, on the other hand, learn from user behaviour.

In academic literature (e.g. Lops, P., de Gemmis, M., & Semeraro, G.: Content-based recommender systems: State of the art and trends. pp. 73-105. Boston, Mass.: Springer US, 2011) the following challenges are often mentioned regarding content-based recommendations:
need for domain knowledge
over-specialization (so called serendipity problem)
user profile creation
item representation.

Social networking has been taken into account in the literature: For instance a publication (Golbeck, J.: Generating predictive movie recommendations from trust in social networks. pp. 93-104. Springer-Verlag Brelin, Germany) shows how trust and social networks can be exploited to refine the user experience. Another publication (Liu, F., Lee, H. J.: Use of social network information to enhance collaborative filtering performance. Expert Systems with Applications, 37(7), pp 4772-4778, 2012) suggests using social networking by emphasizing preferences of those users which, at the same time, are nearest neighbours and belong to the social network of a user.

In EP 2,249,261 Arpit Mathur presents a recommendation system which is based on social networking. In the presented approach preference information of a user is a necessity. Content item, which is accessed by a member of the same group as the said user, is recommended to the user based on this group relation. This is also known as collaborative filtering.

Content-based filtering is utilized in WO 2,009,146,489 by Dalgleish Andrew Robert. An item is recommended to a user by using rules, which determine the links between item features and the user's personal features.

Fishman Alex and Chai Chai Crx K. introduce a community-based recommendation engine in US 2,010,064,325. User receives a content recommendation from her contact. The recommendation engine determines the action to be performed according to the recommendation and on one or more rules, such as trust level of the contact, etc.

Based on similar relevance values as above, such as trust or similarity between the search user and the entity providing the search results, a recommendation system is presented in US 2,011,010,366 by Varshavsky Roy et al. The entities may be virtually anything. The relationships between the user and the entity may be created through many different contact mechanisms and may be unidirectional, asymmetric bidirectional, or symmetric bidirectional relationships. The relationships may be different based on topic or other factors.

In EP 2,207,348 Barbieri Mauro and Pronk Serverius examine the challenges related to insufficient metadata. They present an apparatus for controlling of a recommender system which provides recommendations for a new, unknown domain, or area of interest, by using one or more user profiles from other, known domains. This is achieved by forming or using translations or relations between the known domains and the new domain, and by exploiting these translations or relations to extend the profiles in the known domains into the new domain.

Becker Ralf et al. present an invention (EP 2,242,259) optimized for cross-domain recommendations by enabling the issuing of a recommendation for related predetermined content at a particular appropriate timing. Taken into account in the process are current broadcast content, past and future programs available from a service network and the user's viewing history.

Foster Benjamin et al. describe, in US 2,010,325,011, a method to facilitate generating listing recommendations to a user of a network-based commerce system.

This method identifies a search term that corresponds to a category of items, which includes a plurality of listings hosted by a network-based system. Furthermore, a recommendation query is generated that includes the identified search term. A listing is identified from the plurality of listings as a recommended listing. The identification is based on the recommendation query.

Based on user's listings representing items for sale on the marketplace, user profile is formed, in WO 2,010,114,903 by Kassaei Farhang. The user profile is compared with other similar users who have subscribed to various applications, and the impact those applications have had on the metrics of the similar users is calculated in order to determine what impact the applications will have on the user in question. The impact, combined with user preferences, is used to suggest appropriate applications to the user.

Murphy Shawn M. et al. present in US 2,010,325,205 an event recommendation service. Known selection data is compared with media content selected by a user, location data that corresponds to location of the user and event data are used to make recommendations of events the user is likely to attend.

Thus many prior art solutions somewhat regrettably disclose users' personal history or personal preferences in a process of requesting a recommendation. Yet, constructing a recommendation system seems to require various tedious preparatory stages of collecting and processing metadata associated with entities belonging to the potential recommendation space or receiving the recommendations.

It should be noted that trading personal information has become a significant business e.g. in loyalty card programs and social media. In these cases there is business value in aggregating user data while the monetary benefit for each user is relatively low. An approach has been proposed that a user could directly sell his profile data. Without middlemen there is at least in theory an opportunity to get most value in return from providing the data. However, with the conventional approach the user may be able to trade or exchange his profiling data for one entity only once, since the data is expected to remain fairly static.

Further, implementing and adopting typical standalone recommendation systems may generally easily fall into a number of pitfalls that basically relate to the uniqueness and seclusion of each particular solution as whenever new entities such as users, articles for trade or consumption, etc. appear therein, they simply lack the characteristic profile data and data based on interaction history that is, however, in most such solutions necessary for determining relevant matches between them. Often it is a matter of first finding K nearest neighbors for a new entity, upon which recommendations can then be based on. The selection of neighbors affects to the quality of recommendations, and it requires enough data from the entity. In other words, it takes a long time or at least a considerable amount of adaptation for a new entity to be integrated in an isolated solution in terms of meaningful, valid recommendations from the standpoint thereof. Since the vast majority of contemporary recommendation engines are based on data gathered from a single service, this cold start problem is almost inevitable. In these cases, since data is gathered from a single service, the scope lacks a holistic view of overall user preferences.

Also, many contemporary recommenders have large and sparse data matrices with users as one dimension and items as another. As the number of users and items increase, the mere size of the matrix becomes a computational challenge.

Building up and dynamically managing recommendation engines and e.g. related sensitive/private information such as user profiles or preferences locally in secure manner with appropriate databases, is not in the core focus of most e-service providers like media houses or e-commerce operators either unless, in return, they can clearly provide better-targeted content to the users. Indeed, inaccurate or too narrow-sighted recommendations may cause more annoyance than obtaining no recommendations at all. On the contrary, from a user point of view, happy surprises, often referred as serendipity, are not typically provided by most contemporary content-based recommenders.

In contrast to traditional thinking according to which personalization is based on gathering information of personal preferences and disclosing them to service providers, a safer to use recommendation system relying on adaptive token sets may be constructed. Patent application publication WO14029904 discloses a mechanism for maintaining personal token sets of identifiable tokens for different entities such as users, e-services like Internet-accessible web sites, and e.g. data elements (media items, files, web pages, product descriptions, etc.) accessible through the services. Based on interaction between typically two entities, including, for instance, a user visiting a web page incorporating a data element the user inspects or ‘clicks’, i.e. accesses, the token sets of the associated interaction parties are updated to resemble the token set of the other party more than prior to the interaction. Such update action may comprise copying tokens between the sets. The past interactions of an entity will be thus reflected by its token set in the construction of the set.

FIG. 1 illustrates one basic concept underlying the aforementioned publication '904, wherein token set 17, 29 associated with each interacting entity 21, 22 is updated 214, 215 as a result of the interaction 18 between the entities and based on the token set of the other entity. The entities 21, 22 may refer to a user and an e-service or e-service resource the user is interacting with, for instance. The update of a token set 17, 29 involves information exchange 28, particularly receiving at least part of the other token set 29, 17. Tokens 24 associated with the first interacting unit 21 may be updated by copying thereto a number of tokens from among the tokens 25 associated with the second interacting unit 22, for instance, whereupon the token sets 17, 29 will increasingly share common tokens after the interaction. The actual number of tokens copied may be determined as a percentage 27 indicating how large the intended change to the token set is (whereas in contrast, percentage 26 indicates the portion of the original token set 24 to remain unaltered during the interaction 18). The percentage 27 may indicate the number of tokens copied relative to the total amount of tokens in the set. Choosing the tokens to be copied from the other token set may be based on a random selection.

Accordingly, recommendations for potentially interesting entities/items may be searched from the standpoint of a target entity, such as an e-service user, by determining the token sets of candidate entities that are most similar with the token set of the target entity. These most similar, in terms of token sets, entities could be then recommended to the target entity.

It has been found, however, that even the concept presented in '904 could be developed further in terms of certain use scenarios. Frequently, past interests, habits, etc., as reflected by the past interactions and information updated and stored in the token sets, certainly provide a solid, positive basis for estimating user interests, and therefore, items worth recommending, but that is not solely, always or permanently the case. For example, some of the interactions, even if taking place, may be disappointing or people's interests/habits may eventually, sometimes even abruptly, change, which may easily take place in response to changes in the prevailing environment. Indeed, abrupt changes may involve, among other scenarios, people moving to a completely new location and environment perhaps lacking some facilities/activities the previous habitat was able to provide but offering something new instead, which also adapts people's interests, potentially even radically.

When considering token set management from a purely technical standpoint, overly large token sets comprising a very large number of tokens may be resource-consuming in view of the necessary processing capacity, memory capacity and data transfer capacity of the underlying device hardware. Therefore, a solution for maintaining the token sets reasonable in the light of the aforesaid capacity issues while preserving their great though implicit expressive power in determining recommendations etc., is seen worth sought after.

### SUMMARY

The objective is to alleviate one or more problems described hereinabove not yet fully satisfactorily addressed by the known token based interaction logging and recommendation arrangements, and to provide a feasible solution for the management of token sets in order to enable provision of recommendations with enhanced accuracy and topicality.

The objective is achieved by embodiments of a method and arrangement in accordance with the present invention.

Accordingly, in one aspect of the present invention, a method for adapting an obtained digital first token set comprising a plurality of tokens, the first token set being associated with a first entity, such as a user of an electronic device, wherein the tokens of said plurality are identifiable elements of substantially no semantic value, the first token set being maintained between and updated responsive to interactions between the first entity and one or more other entities, the token sets of which are also updated based on the interactions, said method comprising
detecting interaction between the first entity and another entity, optionally a digital media element such as a web site, web page or a digital resource accessible therethrough, a second token set being associated with the second entity,
determining at least one control value regarding the first token set based on the interaction, wherein interaction feedback obtained through user input or interaction frequency is configured to affect said at least one control value, and
altering the construction of the first token set in accordance with the determined at least one control value, and storing the modified token set to enable subsequent adaptation in connection with interactions and provision of related recommendations of entities.

The at least one control value may relate to the first token set as a whole or to one or more tokens thereof as will become clear to a skilled person based on the description hereinbelow.

Optionally, at least one control value may be also determined regarding a second token set associated with the second entity and utilized for altering the construction of the second token set. Optionally, at least one common control value may be applied for altering the construction of both sets.

Generally, the at least one control value may define or include a value that is temporally permanent or static in a sense that it is maintained either as is or subject to optionally gradual updates between interaction events. Alternatively, the value may be determined specifically in connection with each interaction without applying history information, i.e. in that sense it may be substantially temporary and interaction-specific, and be after one-time use, discarded or overwritten without heritance effect.

In one embodiment, the at least control value includes at least one feedback control value, or ‘rating value’, preferably affecting the construction of the first token set and optionally the second set as a whole. The feedback control value is responsive to interaction related feedback information, or ‘rating’, provided by the first and/or second entity, preferably e.g. the user of the electronic device; the feedback may be provided upon or responsive to the interaction via the user interface of the electronic device, for instance. Feedback given by an entity may indicate e.g. the level of general satisfaction regarding the interaction and/or attitude toward the other entity of the interaction, among other options.

The feedback may be of numerical nature or be at least convertible into such. It may include binary feedback generally indicative of positive or negative conception regarding the interaction with reference to ‘thumb up’ or ‘thumb down’ style feedback mechanisms, for example. Such feedback may be conveniently provided by a user via selection of a graphical symbol on a graphical user interface optionally via a touch screen, for instance. Alternatively, the feedback may be provided using a finer resolution or finer ‘grid’ with three or more potential alternative values, indicative of more negative, more positive and optionally neutral attitude (e.g. no thumb at all) towards the interaction. The stronger the opinion presented in the feedback, the more impact it is configured to advantageously have in altering the construction of at least one related token set.

In some preferred scenarios, positive or neutral feedback and resulting feedback control values may be translated, according to the adaptation logic used, into copying tokens between the first and second token sets of the first and second entities, respectively, whereupon the first set adopts a number of tokens from the second set and preferably vice versa. Therefore, in more general sense one may implement the same ideology by adapting the token sets to increasingly resemble each other. Adding resemblance may incorporate adapting the existing tokens in the set(s) instead of or in addition to copying activity.

In some preferred scenarios, negative feedback or neutral feedback and resulting feedback control values may be translated into diverging the two token sets from each other, which may involve deleting a number of tokens, e.g. tokens that are common to both of the first and second sets, from the first token set or adding non-common tokens, i.e. tokens not also present or presented in the second token set, thereto. Generally the same or at least similar approach may be applied to the second token set in view of the first set. Optionally random tokens may be added to either set or both the sets.

In some preferred scenarios, the more positive or negative the received feedback is, the larger the changes made to the token set(s) are according to the used adaptation logic exploiting the feedback control values. More positive feedback may therefore result in making the token sets more similar by copying or other adaptation actions, for example, than in cases with less positive, neutral or negative feedback.

Correspondingly, more negative the feedback is more comprehensive the diverging actions regarding the token set resemblance, such as deletion of common tokens or addition of non-common tokens, may be.

Each feedback control value indicative of user feedback/rating relative to the interaction may be temporary by nature and relate to the particular interaction event only, i.e. after adapting the token set accordingly, the value can be considered as consumed and be discarded without remaining historical effect in the future interactions and related feedback-based adaptation actions of token sets.

In another, alternative or supplementary, embodiment the at least one control value includes a lifespan value affected by the interaction frequency. Each token set may be associated with at least one, preferably dedicated, lifespan value that is configured to determine the pace and/or amount of automated divergence relative to other token sets. The other token sets may refer to other sets in general or a selected sub-set of other sets such as the sets of the entities with which interactions have taken place in the past optionally during a certain time window.

Preferably, an occurrence of an interaction is translated into a reduced divergence rate as indicated by the lifespan value. The lack of interactions, which may be monitored per selected time window such as daily, weekly, monthly or annually, may be translated into a faster divergence rate as indicated by the lifespan value, which is adapted accordingly.

Diverging of a token set may again incorporate adding a number of new token(s), optionally random tokens, thereto and/or deleting token(s) therefrom, for example.

In a further, either supplementary or alternative, embodiment the at least one control value includes a novelty value. This value may be allocated to each token independently, for instance. The value indicates the currency or recency of the associated token and responds to the presence or effect of the token in the past interactions therefore reflecting interaction frequency on token level.

In other words, receiving a token or information calculated using it in a token set during an interaction may add to the novelty value associated with the token. An existing token may have its novelty value updated whereas a completely new token introduced in the set may have its novelty value set as default. The novelty value thus indicates the frequency of the particular token in interactions, which may be applied in a number of ways. Accordingly, connections as indicated by tokens can be spread fast between entities. Tokens with high(er) novelty values may be given more weight in similarity determination and related recommendation actions.

In contrast, tokens with low novelty values, according to the used criterion, may be deleted from a token set during e.g. a token set maintenance action, which may be necessary to keep the size of the set moderate from the standpoint of required processing and memory capacity. In case the tokens are ordered according to the novelty value in the set, such maintenance action may involve token set truncation to delete the least used tokens from the set. The order or position of the tokens within the set may be utilized to indicate the novelty value of each token without necessity to explicitly store, transport and change the value with each token.

In a further, either supplementary or alternative, embodiment the at least one control value includes a weighting value. A token, preferably each token, in a token set is associated with a dedicated weighting value. A weighting value, as the aforesaid feedback control value, may be generally responsive to the user feedback obtained regarding an interaction. Positive feedback and negative feedback may be reflected by the weighting value. Weighting values may be applied in similarity/recommendation actions; further use scenarios and embodiments of the weighting values are described in more detail in the detailed description hereinafter.

In another aspect of the present invention, an electronic arrangement comprising one or more, at least functionally connected, electronic devices, such as one or more servers optionally residing in a cloud computing environment preferably accessible via the Internet, for adapting a first token set associated with a first entity and comprising a plurality of tokens, wherein the tokens of the plurality are identifiable elements of substantially no semantic value, the first token set being maintained between and updated responsive to interactions between the first entity and one or more other entities, the token sets of which are also updated based on the interactions, comprises
token set management entity configured to alter the construction of the first token set responsive to at least one control value, and
control value management entity configured to determine said at least one control value based on interaction feedback obtained through user input or interaction frequency.

A computer program (product) comprising code means adapted, when run on a computer, to execute an embodiment of the suggested method may be provided. Accordingly, a carrier medium such as a non-transitory storage medium, optionally memory card or optical disc, having the computer program embodied therein may be provided.

The utility of the present invention is due to a variety of factors depending on each particular embodiment thereof. The token sets associated with the interacting entities may be made less similar than prior to the interaction in cases wherein the received user feedback is negative, whereas positive feedback or ‘rating’ may still be translated into increased similarity of the sets. As interactions are indeed not always considered positive from the standpoint of the users even if they do take place in the digital world (considering e.g. a scenario in which a user will find a news article or other media item such as a video clip he/she initially thought interesting, ultimately rather disappointing), more accurate recommendations may be provided and simply inaccurate or ‘bad’ recommendations omitted in the longer run by adapting the token sets differently depending on the nature of the feedback. Through divergence of the sets in the case of negative feedback, the risk of receiving a recommendation of the same or similar disappointing entity is basically reduced. Still, many advantageous features preserving user privacy or anonymity may be maintained with the embodiments of the present invention.

On the other hand, exploitation of lifespan values and related automated diverging of token sets deals with the aforementioned scenarios of interest/habits evolution that usually takes place with people as the time goes by. The interests, friends, environment, etc. may change and possibly rather ancient activities indicated by the possibly seldom used or updated token sets lose their meaning as well in the context of making related recommendations reflecting user interests.

Yet, novelty values further enable rapidly spreading tokens about current interactions between the (token sets) of active entities so that that recommendations can be kept up to date and new token sets/entities may be quickly adopted in recommendations when their popularity/interaction frequency is high.

Further utilities of the embodiments will become evident to a skilled person based on the detailed disclosure set forth hereinafter.

The expression “a number of” refers herein to any positive integer starting from one (1), e.g. to one, two, or three.

The expression “a plurality of” refers herein to any positive integer starting from two (2), e.g. to two, three, or four.

Ordinal numerals such as “first”, “second”, or “third” are generally used herein just to distinguish physical or logical elements from each other without reference to any particular priority or order, if not otherwise explicitly stated.

The term “e-service” refers herein to any electronic service or application that may be accessed by a number of users e.g. via a communications network. The e-service may indeed be accessed using information and communication technology, such as but not necessarily the Internet and/or other network(s) or communication medium. The e-service may include or be based on a number of different aspects of (e-)commerce, online or web service in general, data storage service, data access service, data creation or modification service, computing or processing service, data transfer service, news or article service, communication service, social networking service, publication database, discussion forum, data indexing or search tool, or advertising medium among various other options.

Different embodiments of the present invention are disclosed in the dependent claims.

### BRIEF DESCRIPTION OF THE RELATED DRAWINGS

Next the invention is described in more detail with reference to the appended drawings in which

FIG. 1 illustrates a basic prior solution for adapting token sets associated with different entities in connection with interactions taking place between the entities.

FIG. 2 illustrates an embodiment of the present invention regarding user feedback acquisition and exploitation in adapting the token sets.

FIG. 3 illustrates an embodiment of the present invention regarding the use of lifespan values.

FIG. 4 illustrates an embodiment of the present invention regarding token novelty analysis and practical implications thereof.

FIG. 5 is a flow diagram of a method in accordance with an embodiment of the present invention.

FIG. 6 is a high-level block diagram of an electronic arrangement in accordance with an embodiment of the present invention.

### DETAILED DESCRIPTION OF THE EMBODIMENTS

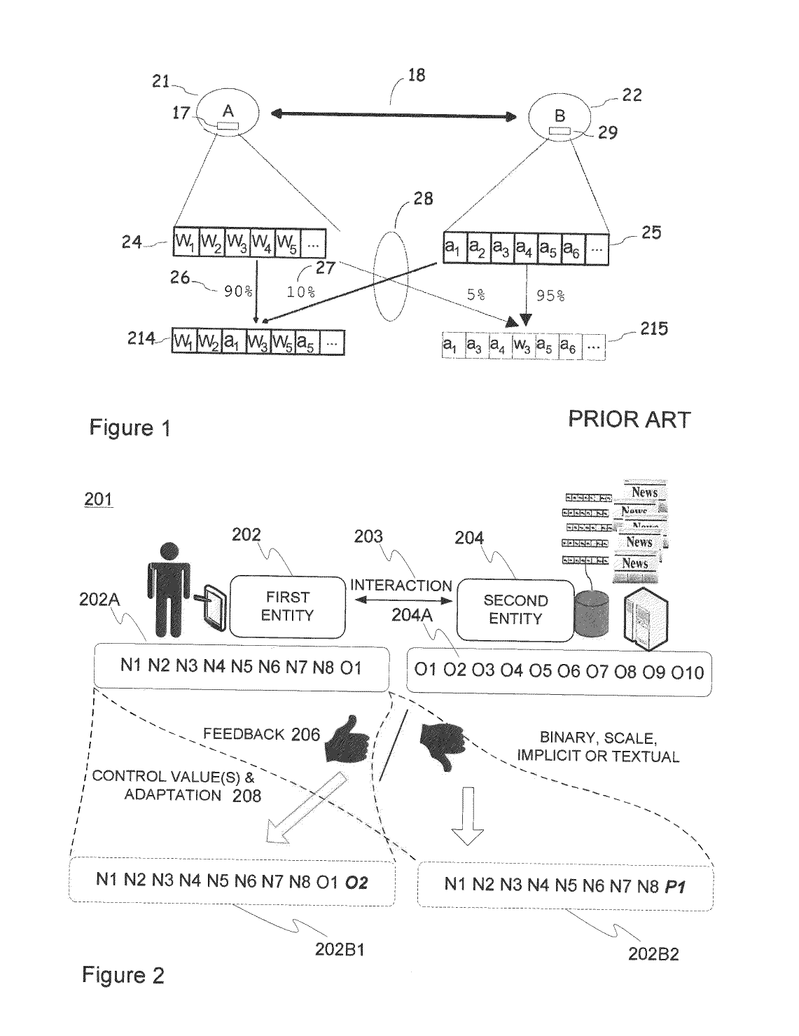

FIG. 1 was already contemplated hereinbefore in connection with the description of background and historical data relating to the origin of the present invention.

FIG. 2 illustrates, at 201, an embodiment of the present invention regarding user feedback acquisition and exploitation in adapting the token sets.

A first entity 202, such as a user operating a terminal device, optionally a mobile terminal, tablet, laptop, desktop or wearable computer, is interacting 203 with a second entity 204 such as an e-service (server(s)) or particular digital resource like a media item (document, image, video, sound file, a hybrid element such as image-incorporating text document, etc.) available therethrough. Interaction may incorporate accessing such entity by a feasible user interface (UI), optionally a web browser.

A first token set 202A is associated with the first entity 202 and a second token set 204A is associated with the second entity 204. The sets 202A, 204A may include equal or different number of tokens. The tokens included (N1, N2, . . . , O1; O1, O2, . . . , O10) are identifiable elements at least most of which preferably lacking any semantic value. They preferably still carry or exhibit at least their own id, which may be numeric (e.g. integer value) or an alphanumeric string, for example.

Upon or after the interaction, e.g. the first entity 202 may provide associated feedback 206 via a suitable feedback provision mechanism, which has been made available to him/her. The mechanism may include e.g. graphically identified feedback elements such as symbols for positive and negative feedback, a feedback slider, an input field for numerical feedback value within a predefined range, etc. provided through the UI, optionally a browser-accessible web page.

The feedback mechanism may support obtaining binary type feedback (positive/negative, −/−, thumb up/down) or feedback of finer resolution or ‘grid’. Neutral feedback, or omitting giving feedback, is yet one option. Neutral/no feedback may be translated into positive feedback, negative feedback or processed separately from the standpoint of token set management and adaptation depending on the embodiment. In some embodiments, no feedback is considered as negative feedback as such passivity may be considered as “no interest” in the interaction or other interaction party (entity).

In some embodiments, the feedback provided may comprise textual elements such as free-form text. Accordingly, the arrangement, or generally entity, processing the feedback may be configured to subject the textual feedback to semantic analysis or parsing to qualify it according to the desired scale. Yet, audio feedback may be obtained and qualified, optionally first funneled through a predefined speech-to-text conversion algorithm.

Depending on the feedback either or both the token sets 202A, 204A associated with the interacting entities 202, 204, respectively, may be updated.

In some cases, each entity 202, 204 may provide interaction-related feedback. This may occur e.g. in use scenarios wherein two user entities interact. The feedback obtained from several sources may be integrated first according to predefined logic or utilized separately for the adaptation of the associated token sets.

In the figure, two scenarios for updating only the first token set 202A are shown at 202B1 and 202B2 for clarity purposes, but a skilled person will appreciate the fact that similar or different update measures could be targeted to the second token set 204A as well, either in addition to or instead of modifying the first set 202A. Feedback data such as control values may be signaled between different entities separately or together with token data.

Accordingly, the feedback 206 either explicitly defines or provides at least information such as textual input to enable defining one or more feedback control values, or ‘rating values’. The feedback control value(s) are utilized to adapt 208 the token set 202A.

For example, in the case of positive feedback control value indicative of positive feedback, the scenario at 202B1 may take place. The first modified token set 202B1 has been adapted to increasingly resemble the second token set 204A. This has been accomplished by token exchange, i.e. adding an instance of token ‘O2’ from the second set 204A (where it will also remain) to the set 202B1. Optionally, a number of further tokens present in the set 204A could be added to the adapted first set 202B1. Instead of or in addition to copying actions, increasing the resemblance may generally include executing a number of other actions for the purpose such as replacing a token in the set 202B1 with a token from the second set 204A, or deriving new tokens based on the second token set 204A and optionally the initial first set 202A.

In the case of negative feedback control value indicative of negative feedback, exchange of tokens is preferably not executed, or its effect is subsequently cancelled or omitted in case the feedback is obtained only afterwards.

Instead, a number of tokens, e.g. common token(s) to the sets 202A, 204A, may be deleted and/or new, optionally random, tokens added to the token stack so that the first token set will decreasingly resemble the second set. In the shown scenario, adapted first token set 202B2 has been provided with a new token ‘P1’ not present in the second token set 204A and a common token ‘O1’ has been deleted.

Generally, more positive the feedback is, more similar the token sets of the interacting entities may be made during the adaptation. This may be realized by increasing the token exchange with the degree of positive feedback, for example. Correspondingly, more negative feedback turns into more severe token set diverging actions such as deletion of tokens (e.g. common tokens) and/or insertion of random tokens in the set(s).

Having regard to recommendation actions wherein generally similarities between token sets are searched for, diverging the token sets as suggested above naturally decreases the similarity thereof and reduces the possibility of a related recommendation in the future as matching the entities underlying the two sets yields lower similarity than before.

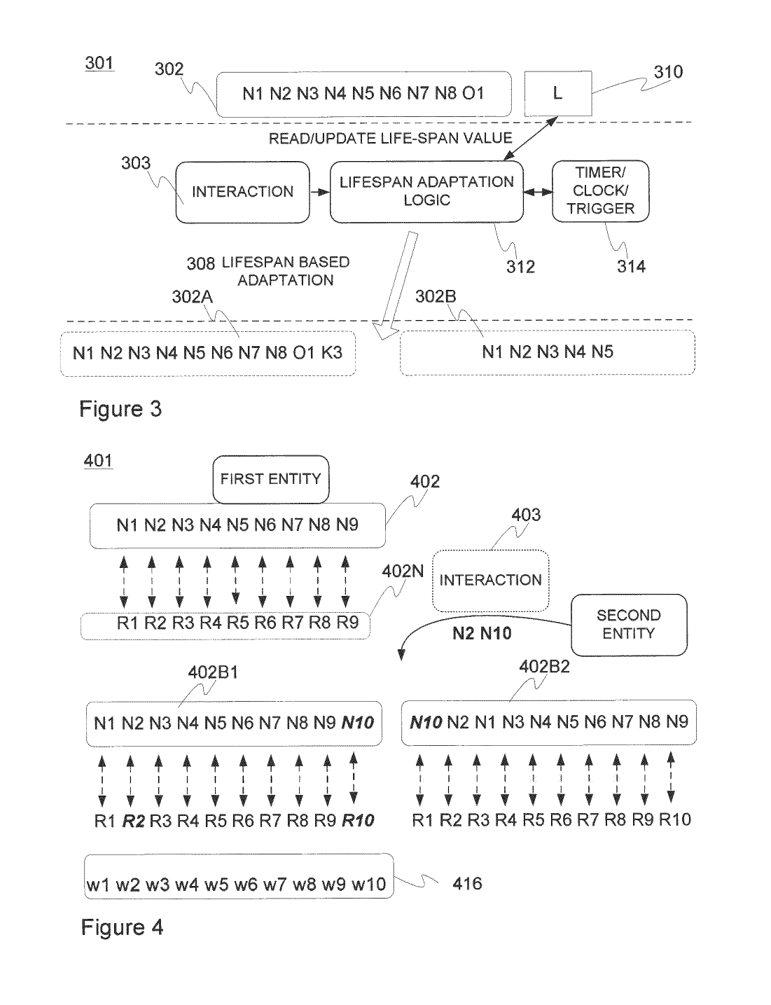

FIG. 3 illustrates, at 3O1, an embodiment of the present invention regarding the use of lifespan values.

A token set 302 is associated with at least one, preferably dedicated/token-set specific, control value or attribute (‘L’) that may be deemed as a ‘lifespan value’ 310. Further attributes such as novelty values and/or weighting values may be utilized as well, but their usage is described in more detail hereinlater in connection with the review of FIG. 4.

The lifespan value 310 of the token set 302 is configured to temporally characterize the adaptation or adaptation rate of the set. A lifespan value may concern all the tokens of the plurality in the set, or a number of selected tokens only. For instance, the lifespan value 310 may represent the lifetime or half-life of the concerned set. As a result, some tokens in the token sets, and thereby the sets themselves get automatically renewed after a while and especially during passive periods of interactions.

The lifespan value 310 will preferably stipulate how fast the token set 302 will automatically diverge, i.e. lose the resemblance with other token stacks, also while in a passive state or ‘idle state’ where no feedback is obtained or interactions generally take place.

In the shown, merely exemplary, scenario the token set 302 is associated with a lifespan value 310 and lifespan adaptation logic entity 312 is configured to update the lifespan value 310 based on interactions 303 of the entity associated with the token set 302, and thus the token set 302, with other entities/token sets. It 312 may further utilize timer, clock, or other triggering input to adapt the token set 302 in accordance with the set lifespan value 310.

An occurrence of an interaction 303 may be configured to alter the lifespan value (increase half-life or reduce divergence rate, depending on the definition of the lifespan value) in a manner that reduces the automated divergence of the concerned token set 302. It may reduce the amount of divergence per each diverging action and/or reduce the rate of diverging actions.

Lack of interactions 303 may be configured to alter the lifespan value to direction that increases the divergence (amount and/or rate).

Temporal monitoring of (lack of) interactions and related token set and/or lifespan value adaptation actions may be achieved by the logic 312 through the utilization of timer or clock data 314, for example. Monitoring rate may be predetermined or adaptive.

At 302A, potential adapted version of token set 302 is shown with added new token ‘K3’, which may be randomly selected so that that token set diverges from the ones it has been previously interacting with.

At 302B, another adapted version of token set 302 is shown. This time four tokens, ‘N6’, ‘N7’, ‘N8’ and ‘O1’, such as random tokens, oldest tokens or selected tokens common with a number of other token sets (provided that such information is available and e.g. stored regarding the set) encountered earlier in connection with interactions, have been deleted therefrom.

When tokens are deleted from or added in the set 302 according to the guidelines set forth above, the set 302 will generally decreasingly resemble other token stacks. As mentioned in connection with the description of FIG. 2, diverging action targeted toward a token set in view of other sets will reduce its similarity with the other sets, whereupon similarity-based recommendation engine does not match the concerned set with the other sets as easily as before in the future.

FIG. 4 illustrates, at 401, one embodiment of the present invention incorporating novelty values in the token sets associated with tokens thereof.

Prior to going into details, some background motivation could be provided with reference to a hypothetical, more classic-appearing scenario involving banknotes and particularly, exchanging banknotes with individual serial numbers. If we repeatedly exchanged banknotes with other people we met and over a cashier desk wherever we went, and wrote down a list containing the serial numbers of the banknotes which have been in our possession, our friends and other people with similar habits, as well as places we visit, would have a tendency of having the same serial numbers in their lists as we have had. This underlying idea has been developed further in the present invention and embodied technically.

In some circumstances, especially when there is an interest in concurrent events, it is likely that especially those serial numbers which we have got most recently are more important, whereas there is a general interest which is not depending on time, all serial numbers may be just as important. Nevertheless, we would be expected to get banknotes, and thus serial numbers, on a fairly random basis. This means that there would be a proportion of serial numbers that come in just once and do not exist in the lists of our friends, either. Thus, it would be wise to remove those serial numbers first which we have not received in ages. Furthermore, some events in which we have received the banknotes may not eventually be for us. It would be beneficial to give these serial numbers a negative valuation: reminding us that these serial numbers may be related to something we specifically do not want. However, even with negative valuation, their existence in the set or list could be valuable. These positive and negative valuations may relate to feedback and related ratings. Whereas interactions may typically be a positive, some interactions are likely to be related to negative experiences, leading to positive and negative valuations.

Reverting now to FIG. 4, a token set 402 comprises a plurality of tokens (N1, N2, . . . , N9). At least two tokens, advantageously all of them, are associated with at least one attribute, at least a novelty value (R1, R2, R3, . . . , R9) 402N, and optionally other attributes such as a weighting value or factor, or context information.

Instead of or in addition to explicit, dedicated novelty values 402N managed and provided with the tokens, novelty values may be indicated via the locations of the tokens in the token set 402, which can be in this embodiment logically also called as stack. In one end, are the least novel tokens located whereas the other end comprises the most novel ones. Accordingly, the tokens in the set or stack 402 may be sorted by their novelty. Even if tokens are provided with explicit novelty values, they may still be sorted according to the novelty to facilitate processing actions such as token set truncation based on novelty, which can be then cleverly targeted to either end of the stack. In case only implicit novelty values are utilized as reflected by the position of each token in the stack, the values as such may be considered as fixed but the tokens update their mutual position in the stack according to the changes in the novelty thereof.

When receiving a token (N2) that already exists in the stack 402, which may happen during the token exchange relating to an interaction 403 between entities, the novelty value (R2) of the token is preferably increased. This can be accomplished by a number of ways depending on the embodiment and used novelty value allocation and maintenance method.

Two possible scenarios are shown in the figure. The token in question may be moved to or at least towards the predefined top of the stack (top is in this example on the left), which has already taken place in the adapted token set 402B2.

The remaining tokens may be shifted accordingly. Alternatively or additionally, the explicit value associated with the token could be updated with reference to token set 402B1, wherein novelty value R2 has been revised.

When receiving a new token N10 which did not previously exist in the token stack 402, again several scenarios are possible depending on the embodiment. The novelty value of new token N10 is preferably set as the highest by placing it to the top of the stack, as being done at 402B2, and/or explicitly allocating it with the highest value ‘R10’ as shown at 402B1.

Considering the usage of novelty values, in some embodiments it may be advantageous for the adaptation process to provide tokens to other entities using e.g. random but still weighted selection, more recent tokens, i.e. tokens with greater novelty values, having a priority over others. As a result, entities, such as users, interacting with common other entities within a short period of time are likely to exchange same tokens with each other, whereupon implicit indication of such interactions and preferences may be rapidly spread. Especially when it comes to recommendations which are contemporary by nature, such as news articles, it is advantageous to give priority to tokens which have highest novelty value.

Choosing the tokens to be copied from the other token stack due to interaction may indeed be based on a random selection and novelty values. For instance, the selection method could be as follows, emphasizing the importance of the novelty value the more tokens there are to be copied:

a) sort all tokens by their novelty value, most novel on the top

b) for selecting the first token to be copied, randomly select one token from all the sorted tokens

c) for selecting the second token to be copied, randomly select one token from the upper half of the sorted tokens

d) for selecting the third token to be copied, randomly select one token from the upper third of the sorted tokens, and so forth,

e) avoiding to select the same token more than once by removing the selected token from the token list before selecting the next.

In this respect, other alternative or additional approaches may be used as well, for instance by reducing the scope for selection to an upper half from the scope the previous token had been selected or using weighted selection. A person skilled in the art can experiment the best strategy for each case, e.g. by using some test data.

Additionally or alternatively, other novelty values or measures can be used, for instance implementing an “accessed” timestamp for the tokens, the timestamp being updated every time similar token is received in the exchange. However, implementing a token stack with the most recently accessed tokens on the top enables a computationally efficient update of a token stack.

It may be advantageous to set a maximum size of a token stack, e.g. 1024 tokens. Reaching this maximum size preferably triggers a request to expire tokens from the stack. Advantageously, the tokens with lowest novelty value, optionally located in the bottom of the token stack, will expire first. This request may also be triggered by an external event, caused by an event such as running out of available memory or an explicit commend from an administrator of the arrangement.

Upon expiration, the concerned token(s) may be deleted from the stack. Alternatively, expired tokens remain in the stack but are neglected or considered inactive regarding a number of token-related operations such as token stack adaptation. However, they may be taken into account in some other token-related operations, such as calculating the similarity of different token stacks.

As a result, some tokens in the token stacks, and thereby the stacks themselves get automatically renewed after a while. This makes it possible for a user to dynamically provide or trade his token stack data to an entity multiple times when desired instead of fearing that a once provided stack will remain valid or usable by the entity, for instance.

As mentioned hereinbefore, a token may also be associated with other attributes such as a weighting value. Item 416 refers to weighting values associated with the tokens of set 402B1 or 402B2, one weighting value per token. For a new token, the weighting value may be initialized to a constant value, say 1. It is needless to say, the weighting values may be numeric.

Any one or more of the attributes associated with tokens may be integrated therewith such that they follow the tokens automatically when tokens are allocated or moved, i.e. they do not have to be transferred or signaled using a separate, dedicated procedure. Alternatively, at least part of the attributes could be implemented as separate or separable information elements that have to be linked with the tokens by the token id's for example. The attributes could be then provided in dedicated data structure(s) such as lists identifying a number of tokens and related attributes.

Some of the token related attributes may be internal by nature, whereas some of the token attributes may be presented in the token exchange to the other entities. Preferably, one of the attributes to be presented in the token exchange would be the weighting value.

Weighting values may be cleverly utilized for providing token set, or stack, similarity-based recommendations of entities to other entities or parties also associated with a token stack.

As mentioned hereinbefore, it may be advantageous to use integers as tokens, and the number of tokes may advantageously be hundreds, if not thousands.

One feasible option is to base similarity measurement on the following scheme, taking into account both positive and negative weight values w the tokens may have:

$$Similarity = \frac{1}{N} {\sum }_{k = 0}^{n} f ( {w}_{ki} , {w}_{kj} ) \\ f ( {w}_{ki} , {w}_{kj} ) = \{ \begin{matrix}S ( {w}_{ki} * {w}_{kj} ) , & k ∈ {A}_{i} ⋀ k ∈ {A}_{j} \\ 0 , & otherwise\end{matrix} \qquad ( 1 )$$

in which Aᵢ and Aⱼ represent token stacks and k the token value. Recommendations are based on entities which have highest similarity. In this example a sigmoid function was illustrated; the sigmoid function produces an S-curve and is well known by a person skilled in the art of neural computing, an example of such a function presented in the following equation:

$$S ( x ) = \frac{1}{1 + {e}^{- x}} \qquad ( 2 )$$

It should be notes that the value of the sigmoid function always remains between a lower boundary (e.g. −1) and upper boundary (e.g. 1), when x=−∞ and when x=∞, respectively. It is advantageous to have the denominator N compensating different token stack sizes. N could for instance be the number of tokens which exist in both Aᵢ and Aⱼ.

In some applications, such as when providing recommendations for contemporary entities, it would be feasible as one embodiment of the invention to take the novelty value into account by giving more weight to most novel tokens, the novelty of a token k preferably being based on the novelty values (vₖ) available.

$$f ( {w}_{ki} , {w}_{kj} ) = \{ \begin{matrix}S ( {w}_{ki} * {w}_{kj} * {v}_{ki} * {v}_{kj} ) , & k ∈ {A}_{i} ⋀ k ∈ {A}_{j} \\ 0 , & otherwise\end{matrix} \qquad ( 3 )$$

In this equation the novelty value can be for instance based on linear calculation such as giving the most novel token in the token stack value v=1 and the least novel token value v=0.

It should be noted that disclosing the novelty value to a previously unknown, and thus not necessarily trusted, entity may lead to compromising privacy of the entity which is associated to the token stack. Whenever the novelty value v is not available it could be replaced by a constant value, such as an average of known novelty values. When a token stack receives a token which it already has, in one embodiment the existing weighting value may be updated using the received weighting value, for instance by adding up the incoming weighting value whenever the related interaction had positive rating

w′ₖᵢ=wₖᵢ+a*wₖⱼ (4)

or subtracting when the related interaction had negative rating,

w′ₖᵢ=wₖᵢ−a*wₖⱼ (5)

wₖᵢ being the weighting value to be the updated, wₖⱼ the received weighting value and a optionally the strength of the positive or negative rating, for instance 0<a≦1.

It should be noted that the equations above were merely examples of different feasible embodiments of the innovation, not the core innovation itself.

In a further embodiment of the present invention, which can be combined with desired other embodiment(s) described herein, recommendations are generated for a group of users. In group recommendations it is beneficial if personal dislikes are considered carefully. As a trivial example, when searching for a lunch place it should be considered, if there are group members with vegetarian diet, and which of the available lunch places serve vegetarian food. In this case one personal dislike to have meat may have a stronger weight in the decision making.

In this embodiment token stacks of the group are merged, preferably with weighting values, for instance by adding them up for each similar token, and searching for entities with most similar token stacks when compared with the merged token stack. For dislikes, the recommendation may take place by taking into account only tokens with negative S( ).

This negative evaluation can be used for either filtering out unwanted entities (lowest Similarity with negative S( )) in recommendations before searching for recommendations, filtering them out from the recommendation list, or using the list calculated from negative S) as such.

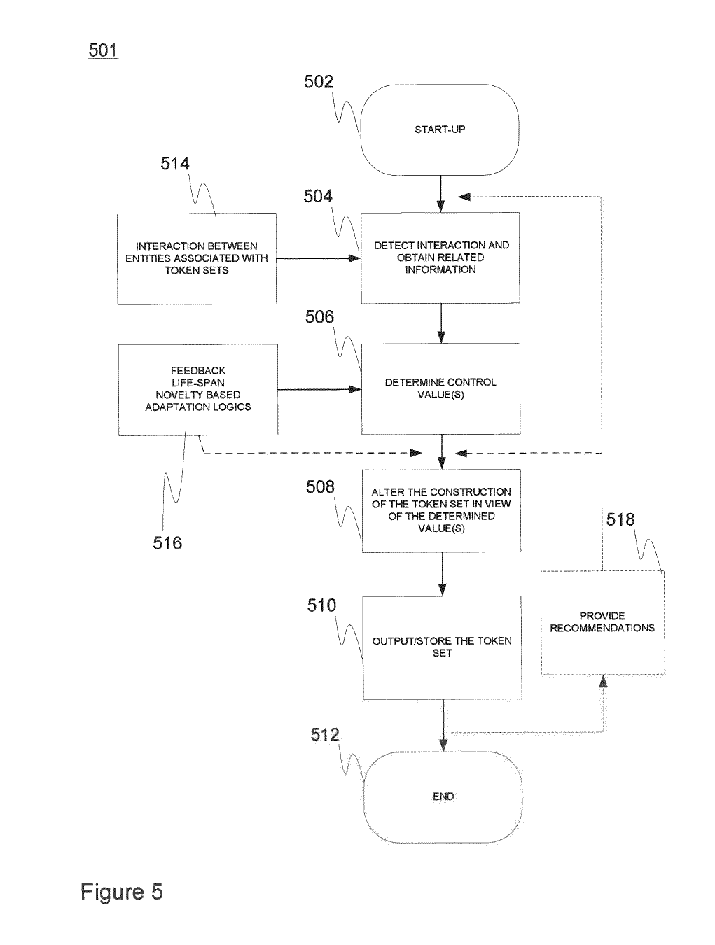

FIG. 5 includes a flow diagram 501 of a method in accordance with an embodiment of the present invention.

At start-up 502, the necessary preparatory actions are taken. For example, entities may be allocated with initial token stacks, different server-based services may be ramped up and terminals configured to access those. Token exchange, adaptation, etc. logics may be adjusted to fulfill the user needs. Associated software may be provided and installed. The method may be performed by one or more electronic devices. For example, a server arrangement of one or more servers may be adapted for the task, or the execution may be split between a number of terminal device(s) and server device(s).

At 504, interaction 514 between a first entity and another entity is detected. The first entity may be user accessing a web site/service via a terminal device, for instance. The second entity may be a digital media element such as a web site, web page or a digital resource accessible therethrough, such as a digital document, video, audio, or image file. A second token set is associated with the second entity. Relevant information such as the token sets with potential attributes is now obtained from a number of remote entities if not already in possession of the device(s) executing the method.

At 506 at least one control value regarding the first token set is determined based on the interaction, wherein interaction feedback preferably obtained through user input and/or interaction frequency is configured to affect the at least one control value in accordance with the various adaptation logics applied 516.

As described in further detail herein elsewhere, the at least one control value or attribute concerning the whole token set or one or more tokens thereof may incorporate at least one value selected from the group consisting of: feedback control value, lifespan value, novelty value, and weighting value.

At 508, the first token set is adapted according to the at least one control value.

Similarly at least one control value regarding the second token set may be determined and the set adapted, although not explicitly presented in the figure.

At 510, the adapted token set is stored for future use and adaptation, and optionally forwarded to a number of other entities for remote use/storage.

At 512, method execution is ended. The dotted loop-back arrow highlights the potentially repetitive nature of the execution of shown method items. The token sets and part of the control values (e.g. novelty values, weighting values, lifespan value) are preferably maintained between updates that may arise from interactions and automated divergence, and in the meantime, used for providing recommendations 518.

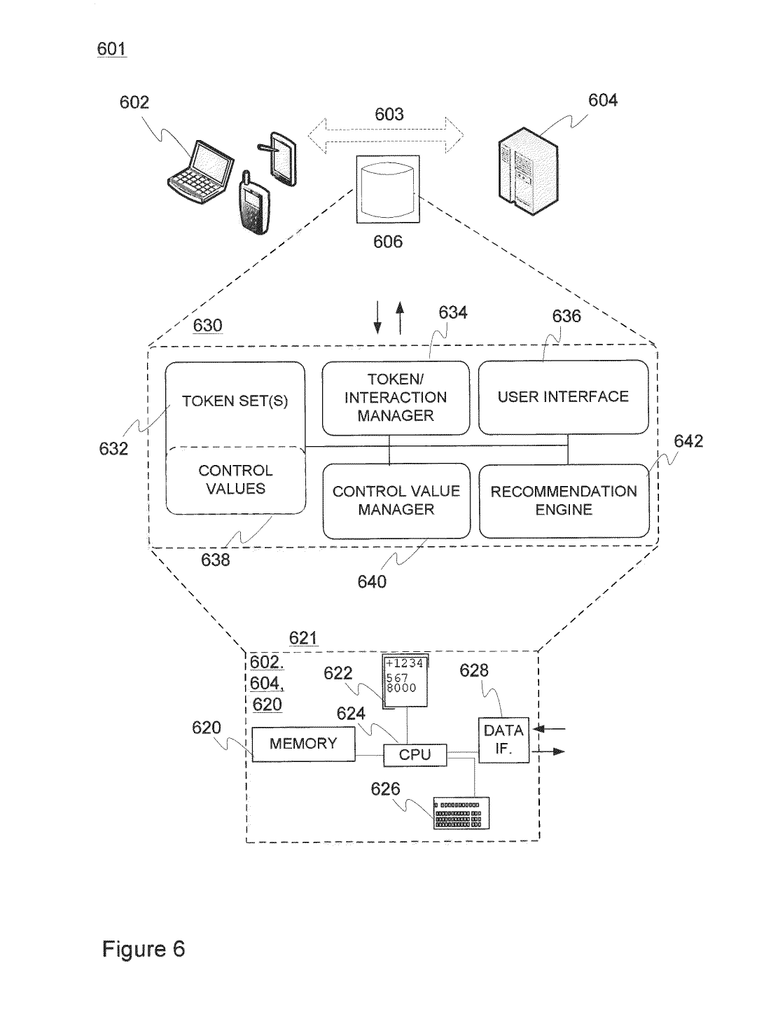

FIG. 6 shows, at 6O1, a high-level block diagram of an electronic arrangement in accordance with an embodiment of the present invention. The arrangement may be realized by a number of server entities such as server(s) 604 hosting the e-service providing access to digital content associated with token sets, such as media items. Alternatively or additionally, at least part of the arrangement may be realized by a terminal device 602. As a further option, a separate centralized entity 606 such as a token repository entity may constitute at least part of the arrangement with a number of elements such as servers. The repository 606 may be configured to manage or store token sets, provide recommendations based thereon, synchronize remote instances (copies) of token sets, etc. When synchronizing the token sets, it is advantageous to synchronize not only the tokens but their attributes as well. Since synchronization would be expected to have some conflicts, such as the same token accessed in several instances of the set, priority in these conflicts are advantageously given to updates instead of deletions. Item 603 depicts the possible communication taking place between the illustrated entities.

Item 630 shows functional/logical elements the arrangement may be considered to have including storage for a number of token sets 632. The control values 638 of the sets, such as novelty values, lifespan value, weighting values, etc. may be stored thereat depending on the embodiment and usage of values. Token set manager 634 may update token sets based on the control values and interactions, while control value manager 640 maintains and updates the control values based on interaction feedback obtained through user input or interaction frequency. As skilled person will appreciate the fact that in practical implementations, the elements 634 and 640 may be implemented by a common software module executed by a number of processors and stored in a number of memory elements like chips, for instance, or divided into smaller constituents when seen beneficial.

User interface 636 may be provided to obtain feedback relative to the interactions and monitoring or configuring the operation of the arrangement. Recommendation engine 642 may provide recommendations of entities to target entity based on the associated token sets and similarities therebetween as described herein.

The engine 642 may thus be configured to obtain information regarding a plurality of token sets associated with a corresponding plurality of entities e.g. from storage 632 or external sources, to determine an indication of similarity between a target token set associated with e.g. a service user and each set in said plurality of token sets, and based on the determined indications of similarity, to establish a recommendation for the user regarding a sub-set of one or more entities from said plurality of entities. Naturally, the recommendation may incorporate a number of entities, the token sets of which are most similar with the target set according to the used criteria.

Opposite criteria could be used to provide anti-recommendations of potentially disliked entities. The engine 642 may further be configured to apply principles reviewed in the description of FIG. 4 relative to novelty values and optionally weighting values in the process.

At 621, a coarse, more hardware-oriented, sketch of the illustrated arrangement's 602, 604, 606 possible internals is provided by means of example only.

The arrangement/device belonging or establishing the arrangement may comprise at least one processor element 624 such as one or more microprocessors, microcontrollers, DSP's (digital signal processor), programmable logic chips, etc. The processor 624 may be configured to execute the computer application code stored in a memory 120, which may imply processing instructions and data relative to a number of application(s) or software modules/entities associated with the present invention for managing token sets. The memory 620 may be divided between one or more physical memory chips or other memory elements. The memory 620 may further refer to and include other storage media such as a preferably detachable memory card, a floppy disc, a CD-ROM, or a fixed storage medium such as a hard drive. The memory 620 may be non-volatile, e.g. ROM, and/or volatile, e.g. RAM, by nature.

A UI may be provided and comprise a display 622, and/or a connector to an external display or a data projector, and keyboard/keypad 626 or other applicable control input means (e.g. a touch screen or voice control input, or separate keys/buttons/knobs) configured so as to provide the user of the device with practicable data visualization and device control means. User feedback may be obtained. The UI may further include one or more loudspeakers and associated circuitry for sound output. Yet, a remote UI functionality may be implemented by means of a web server and web site operated thereat, for example.

In addition, the device comprises a data transfer entity or interface 628 including e.g. a wired network interface such as LAN (Local Area Network, e.g. Ethernet) interface or a wireless network interface, e.g. WLAN (Wireless LAN) via which the device may be connected to the Internet, for instance. Terminal devices may include a wireless cellular interface, e.g. GSM (Global System for Mobile Communications) or UMTS (Universal Mobile Telecommunications System) compliant one. Interface 628 may be applied for transferring token sets and related data such as feedback data.

Reverting to the foregoing logical, software friendly, functionalities for instructing the underlying hardware to carry out the various procedures suggested herein may be implemented as one or more software applications executed by the processor. This computer software (product) may be thus provided on a carrier medium such as a memory card, a memory stick, an optical disc (e.g. CD-ROM, DVD, Blu-Ray™), or some other memory carrier.

Ultimately, a skilled person may, on the basis of this disclosure and general knowledge, apply the provided teachings in order to implement the scope of the present invention as defined by the appended claims in each particular use case with necessary modifications, deletions, and additions, if any.

For example, it can be expected in the context of present invention that few entities may become dominant by frequently interacting with a large number of other entities. For instance, a front page news article is often accessed by almost all readers, not depending on their background or personal preferences. The tokens of these dominating entities spread tokens and cause similarity beyond what would be beneficial for the quality of subsequent recommendations.

Thus it may be advantageous to keep record on how frequently tokens are copied from a token set and reducing the number of tokens to be copied when the frequency is high. For instance, every token set could have a daily quota, how many tokens per day can be copied out, and a selected statistical algorithm could make e.g. a statistical prediction what would be the number of requests. The number of tokens copied out could then be calculated and regulated to approximately fit into the quota.

1. A method for adapting an obtained digital first token set comprising a plurality of tokens, the first token set being associated with a first entity, such as a user of an electronic device, wherein the tokens of said plurality are identifiable elements of substantially no semantic value, the first token set being maintained between and updated responsive to interactions between the first entity and one or more other entities, the token sets of which are also updated based on the interactions, said method comprising
detecting interaction between the first entity and another entity, optionally a digital media element such as a web site, web page or a digital resource accessible therethrough, a second token set being associated with the second entity,
determining at least one control value regarding the first token set based on the interaction, wherein interaction feedback or interaction frequency is configured to affect said at least one control value, and
altering the construction of the first token set in accordance with the determined at least one control value, and storing the modified token set to enable subsequent adaptation thereof in connection with interactions and provision of related recommendations of entities.

2. The method of claim 1, wherein at least one control value indicative of interaction feedback is obtained through user input, and in the case of positive feedback said altering incorporates adapting the first token set to increasingly resemble the second token set, whereas in the case of negative feedback said altering incorporates adapting the first token set to decreasingly resemble the second token set.

3. The method of claim 2, wherein the control value indicative of feedback defines three or more levels of satisfaction, more positive feedback being translated into more similar token sets and vice versa.

4. The method of claim 2, wherein increasing the resemblance includes copying one or more tokens from the second token set to the first set.

5. The method of claim 2 wherein decreasing the resemblance includes diverging the first token set from the second token set through insertion of a new, optionally random, token in the first token set or deletion of an existing, optionally common, token therefrom.

6. The method of claim 5, wherein the second token set lacks the new token inserted to the first token set.

7. The method of claim 1, wherein at least one control value including a lifespan value affected by the interaction frequency is applied during said altering to control the rate of automated divergence of the first token set relative to other token sets.

8. The method of claim 7, wherein detected lack of interactions is translated into an increase in the divergence rate.

9. The method of claim 7, wherein detected interaction is translated into a decrease in the divergence rate.

10. The method of claim 7, wherein divergence incorporates at least one action selected from the group consisting of: addition of a new token in the set, addition of a new random token in the set, deletion of a token from the set.

11. The method of claim 1, wherein at least one control value includes a novelty value associated with a token of the first token set, each token of the set being preferably associated with a dedicated novelty value,
said novelty value being increased responsive to the receipt of the token from the second token set during token set adaptation including token exchange upon interaction between the first and second entities to indicate the recency and frequency of the token in interactions.

12. The method of claim 11, wherein the location of the token in the token set relative to other tokens indicates the novelty value.

13. The method of claim 11, wherein a new token received not previously present in the first token set is allocated the highest novelty value in the set.

14. The method of claim 11, wherein a number of tokens with low novelty values according to the used criterion are deleted or deemed to expire optionally periodically or upon reaching a size limit of the token set.

15. The method of claim 11, wherein tokens with higher novelty values are preferred over others in token exchange upon interaction between the first and second entities according to a predefined logic.

16. The method of claim 1, wherein at least one control value includes a weighting value associated with a token received from the second token set during token set adaptation including token exchange upon interaction between the first and second entities, said weighting value being responsive to the feedback, each token in the first token set being preferably associated with a dedicated weighting value.

17. The method of claim 16, wherein positive feedback is translated into increase in the weighting value of the token received and vice versa.

18. The method of claim 16, wherein during token exchange also a weighting value associated with the token in the second token set is received and applied for determining the weighting value for the same token in the first token set.

19. The method of claim 1, further comprising obtaining a plurality of token sets associated with a corresponding plurality of entities, determining an indication of similarity between a target token set associated with a target entity and each set in said plurality of token sets, and based on the determined indications of similarity, establishing a recommendation regarding a sub-set of one or more entities from said plurality of entities preferably deemed as most similar in terms of the associated token sets relative to the target token set.

20. The method of claim 19, wherein at least one control value includes a novelty value associated with a token of the first token set, each token of the set being preferably associated with a dedicated novelty value,
said novelty value being increased responsive to the receipt of the token from the second token set during token set adaptation including token exchange upon interaction between the first and second entities to indicate the recency and frequency of the token in interactions, and
wherein emphasis is given to more novel tokens in the token sets while determining the indication of similarity.

21. The method of claim 19, wherein at least one control value includes a weighting value associated with a token received from the second token set during token set adaptation including token exchange upon interaction between the first and second entities, said weighting value being responsive to the feedback, each token in the first token set being preferably associated with a dedicated weighting value, and wherein the indication of similarity is determined utilizing the weighting values of the tokens in the token sets, optionally giving emphasis to the tokens with high weighting values according to a predefined scheme.

22. The method of claim 19, wherein at least one control value includes a novelty value associated with a token of the first token set, each token of the set being preferably associated with a dedicated novelty value, said novelty value being increased responsive to the receipt of the token from the second token set during token set adaptation including token exchange upon interaction between the first and second entities to indicate the recency and frequency of the token in interactions, and wherein at least one control value includes a weighting value associated with a token received from the second token set during token set adaption including token exchange upon interaction between the first and second entities, said weighting value being responsive to the feedback, each token in the first token set being preferably associated with a dedicated weighting value, and wherein the indication of similarity is determined by giving emphasis to more novel tokens in the token sets and further utilizing the weighting values of the tokens.

23. The method of claim 19, comprising establishing a combined recommendation of a sub-set of entities from said plurality of entities to a group of target entities, preferably users, each provided with a token set, wherein token sets of the target entities are first merged, according to predefined logic, for determining the indications of similarity relative to the token sets of said plurality of entities.

24. Electronic arrangement comprising one or more, at least functionally connected, electronic devices, for adapting a first token set associated with a first entity and comprising a plurality of tokens, wherein the tokens of said plurality are identifiable elements of substantially no semantic value, the first token set being maintained between and updated responsive to interactions between the first entity and one or more other entities, the token sets of which are also updated based on the interactions, comprising
token set management entity configured to alter the construction of the first token set responsive to at least one control value, and
control value management entity configured to determine said at least one control value based on interaction feedback or interaction frequency.

25. A computer program comprising a code means adapted, when run on a computer, to execute the method of claim 1.

26. A carrier medium comprising the program of claim 25.
